(19) United States
(12) Patent Application Publication
(10) Pub. No.: US 2019/0057390 A1
(43) Pub. Date: Feb. 21, 2019

(54) BIOMETRIC SYSTEM FOR AUTHENTICATING A BIOMETRIC REQUEST

(71) Applicant: MASTERCARD ASIA/PACIFIC PTE. LTD., SINGAPORE (SG)

(72) Inventors: Rajat Maheshwari, Singapore (SG); Benjamin Charles Gilbey, Singapore (SG); Sumeet Bhatt, Jericho, NY (US)

(21) Appl. No.: 16/105,804

(22) Filed: Aug. 20, 2018

(30) Foreign Application Priority Data
Aug. 21, 2017 (SG) 10201706801Y

(51) Int. Cl. G06Q 20/40

(52) U.S. Cl. CPC G06Q 20/40145; G06Q 20/409

(57) ABSTRACT

A biometric system for authenticating a biometric request received from a payment terminal, comprising one or more processors in communication with non-transitory data storage having instructions stored thereon which, when executed by the processor or processors, configure the system to perform the steps of: receiving a payment request from the payment terminal, the payment request including cardholder data and a biometric authentication request; retrieving, from data storage, a key associated with the cardholder data; sending, to the payment terminal, message data representing said key; receiving, from the payment terminal, data representing biometric input from a purchaser; retrieving, from data storage, a reference biometric template associated with the key; comparing said data representing biometric input from the purchaser with the reference biometric template associated with the key; responsive to a determination that said data representing biometric input from the purchaser matches with the reference biometric template associated with the key: generating message data representing a payment authorization request including an indication that the biometric input from the purchaser matches with the reference biometric template associated with the key; and sending, to an authorization system, the message data.

### CROSS-REFERENCE TO RELATED APPLICATION

This application claims the benefit of and priority to Singapore Patent Application No. 10201706801Y filed Aug. 21, 2017. The entire disclosure of the above application is incorporated herein by reference.

### FIELD

The present disclosure generally relates to a biometric system and method for authenticating a biometric request received from a payment terminal. The present disclosure also generally relates to a biometric payment device and method for authenticating a transaction for a purchaser. The present disclosure also generally relates to a biometric payment terminal for authenticating a transaction for a purchaser.

### BACKGROUND

This section provides background information related to the present disclosure which is not necessarily prior art.

Payment cards offer a more convenient mode of payment for both consumers and merchants by allowing transactions to occur without the need for exchanging physical cash. However, payment card based transactions are not without risk. It is possible for fraudulent transactions to be carried out, i.e., transactions which are made without the cardholder's consent. Historically, there are significant technical limitations in fraud prevention. For example, typical cardholder authentication for payment cards with magnetic stripes requires the purchaser to sign and the merchant to verify that the signature matches the cardholder's signature. However, the cardholder's signature is typically presented at the back of said payment card. As such, the fraudulent purchaser need only practice forging the signature to being able to convince the merchant of its authenticity. In most circumstances, the merchant does not carefully check the authenticity of the signature such that it is easier for the cardholder authentication process to be circumvented and fraudulent transactions to be approved.

Although there have been significant technological advances in fraud detection and prevention systems, fraudulent transactions still present a significant problem. Recent advancements in sensor technology coupled with reduced costs have given rise to an increased use of biometric authentication in a wide variety of applications. For example, governments have long adopted the use of fingerprints in keeping records of their own citizens. More recently however, countries such as the United States and Japan have started to record fingerprints of all visiting airline passengers.

The increased use of biometric authentication inadvertently also increases the risk of fraudsters having access to cardholders' biometric data, by means of a data breach, for example. Another method that fraudsters use to obtain cardholders' biometric data is by biometric spoofing. Spoofing refers to the practice of circumventing a biometric authentication system, for example, by “lifting” fingerprints from a credit card, and using the impressions of the fingerprints to create a replica which can be contacted against a fingerprint reader to thereby effect a fraudulent transaction. It is sometimes said that it is safer to use more traditional methods of authentication, such as a password or personal identification number (PIN) compared to biometric authentication, due to the possibility of biometric spoofing, and the fact that it is possible to change one's password or PIN, but not a biometric identifier.

It is generally desirable to overcome or ameliorate one or more of the above described difficulties, or to at least provide a useful alternative.

### SUMMARY

This section provides a general summary of the disclosure, and is not a comprehensive disclosure of its full scope or all of its features. Aspects and embodiments of the disclosure are set out in the accompanying claims.

In accordance with the present disclosure, there is provided a biometric system for authenticating a biometric request received from a payment terminal, comprising one or more processors in communication with non-transitory data storage having instructions stored thereon which, when executed by the processor or processors, configure the system to perform the steps of: (a) receiving a payment request from the payment terminal, the payment request including cardholder data and a biometric authentication request; (b) retrieving, from data storage, a key associated with the cardholder data; (c) sending, to the payment terminal, message data representing said key; (d) receiving, from the payment terminal, data representing biometric input from a purchaser; (e) retrieving, from data storage, a reference biometric template associated with the key; (f) comparing said data representing biometric input from the purchaser with the reference biometric template associated with the key; (g) responsive to a determination that said data representing biometric input from the purchaser matches with the reference biometric template associated with the key: (i) generating message data representing a payment authorization request including an indication that the biometric input from the purchaser matches with the reference biometric template associated with the keys; and (ii) sending, to an authorization system, the message data.

Preferably, the biometric system is further configured to, in said comparing, generate a matching score indicating how closely said data representing biometric input from the purchaser matches the reference biometric template associated with the key. The biometric system preferably successfully authenticates the biometric authentication request responsive to a determination that the matching score is within a predefined threshold.

Advantageously, responsive to a determination that the biometric input received from the payment terminal is data from a sensor, the biometric system performs the step of generating a template from the biometric input by performing the steps of: (a) preprocessing the data from a sensor; (b) extracting the features of preprocessed data from a sensor; and (c) generating a template from extracted features for comparing with the reference biometric template associated with the key.

Preferably, the key retrieved from data storage is one of a plurality of keys forming part of an indexed array of keys associated with the cardholder data, wherein said indexed array of keys correspond with an indexed array of reference biometric templates. Advantageously, responsive to a determination that the retrieved key associated with the cardholder data is one of a plurality of keys, the biometric system is further configured to: (a) retrieve the size of the indexed array of keys; (b) apply a randomized selection of a number between zero and the size of indexed array of keys to obtain a random index number; (c) temporarily store, in data storage, data representing the random index number; and (d) retrieve a key associated with the random index number.

Embodiments of the biometric system advantageously provide a more secure manner of biometric authentication for use in authorizing payment transactions. Embodiments of the biometric system minimize the risk of fraudulent transactions, e.g., by spoofing or data breaches resulting in exposed biometric information, by randomizing the selection of the key and requiring a purchaser to apply the correct biometric input associated with that randomly selected key.

Embodiments of the biometric system provide an additional level of security beyond mere biometric matching against a reference template. Since the person conducting the transaction needs to correctly select which biometric authentication method to use with the transmitted key (e.g., correctly choose from among 10 possible fingerprints, or select iris scanning or facial recognition as the mode of authentication), an additional layer of security is added to the cardholder verification process, thereby reducing the risk of fraudulent transactions.

In accordance with the present disclosure there is also provided a biometric method for authenticating a biometric request received from a payment terminal, performed by one or more processors in communication with non-transitory data storage having instructions stored thereon which, when executed by the processor or processors, performs the steps of: (a) receiving a payment request from the payment terminal, the request including cardholder data and a biometric authentication request; (b) retrieving, from data storage, a key associated with the cardholder data; (c) sending, to the payment terminal, message data representing said key; (d) receiving, from the payment terminal, data representing biometric input from a purchaser; (e) retrieving, from data storage, a reference biometric template associated with the key; (f) comparing said data representing biometric input from the purchaser with the reference biometric template associated with the key; (g) responsive to a determination that said data representing biometric input from the purchaser matches with the reference biometric template associated with the key: (i) generating message data representing a payment authorization request including an indication that the biometric input from the purchaser matches with the reference biometric template associated with the key; and (ii) sending, to authorization system, the message data.

In accordance with the present disclosure, there is also provided a biometric payment device for authenticating a transaction for a purchaser that is initiated by a payment terminal, comprising one or more processors in communication with a biometric sensor and non-transitory data storage having instructions stored thereon which, when executed by the processor or processors, configures the device to perform the steps of: (a) receiving a request for biometric authentication from the payment terminal in communication with the biometric payment device; (b) retrieving, from data storage, a key associated with reference biometric template; (c) sending said key to the payment terminal; (d) receiving, from the biometric sensor, data representing biometric input from the purchaser; (e) retrieving, from data storage, the reference biometric template associated with the key; (f) comparing said data representing biometric input from the purchaser with the reference biometric template associated with the key; (g) responsive to a determination that said data representing biometric input from the purchaser matches with the reference biometric template associated with the key: (i) generating message data representing a payment authorization request including an indication that the biometric input from the purchaser matches with the reference biometric template associated with the key; and (ii) sending, to an authorization system, the message data for payment authorization.

Preferably, the payment device successfully biometrically authenticates responsive to a determination that the matching score, indicating how closely said data representing biometric input from the purchaser relates with the reference biometric template associated with the key, is within a predefined threshold.

Preferably, the key retrieved from data storage is one of a plurality of keys forming part of an indexed array of keys associated with the cardholder data, wherein said indexed array of keys correspond with an indexed array of reference biometric templates. Advantageously, responsive to a determination that the retrieved key associated with the cardholder data is one of a plurality of keys, the payment device further configured to: (a) retrieve the size of the indexed array of keys; (b) apply a randomized selection of a number between zero and the size of indexed array of keys to obtain a random index number; (c) temporarily store, in data storage, data representing the random index number; and (d) retrieve a key associated with the random index number.

In accordance with the present disclosure, there is also provided a biometric method for authenticating a transaction for a purchaser performed by a biometric payment device including one or more processors in communication with a biometric sensor, the method including: (a) receiving a request for biometric authentication from a payment terminal in communication with the biometric payment device; (b) retrieving, from data storage, a key associated with reference biometric template; (c) sending said key to the payment terminal; (d) receiving, from the biometric sensor, data representing biometric input from the purchaser; (e) retrieving, from data storage, the reference biometric template associated with the key; (f) comparing said data representing biometric input from the purchaser with the reference biometric template associated with the key; (g) responsive to a determination that said data representing biometric input from the purchaser matches with the reference biometric template associated with the key: (i) generating message data representing a payment authorization request including an indication that the biometric input from the purchaser matches with the reference biometric template associated with the key; and (ii) sending, to an authorization system, the message data for payment authorization.

In accordance with the present disclosure, there is also provided a biometric payment terminal for authenticating a transaction for a purchaser, comprising one or more processors in communication with a biometric sensor, a display and non-transitory data storage having instructions stored thereon which, when executed by the processor or processors, configure the payment terminal to perform the steps of: (a) receiving cardholder data from a payment device; (b) retrieving, from data storage, a key associated with the cardholder data; (c) generating on a display, message data representing the key; (d) receiving, from the biometric sensor, data representing biometric input from the purchaser; (e) retrieving, from data storage, the reference biometric template associated with the key; (f) comparing said data representing biometric input from the purchaser with the reference biometric template associated with the key; (g) responsive to a determination that said data representing biometric input from the purchaser matches with the reference biometric template associated with the key: (i) generating message data representing a payment authorization request including an indication that the biometric input from the purchaser matches with the reference biometric template associated with the key; and (ii) sending, to an authorization system, the message data for payment authorization.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure. With that said, certain embodiments of the disclosure are hereafter described, by way of non-limiting example only, with reference to the accompanying drawings, in which:

FIG. 1 is a schematic diagram of a system for authenticating a biometric request;

FIG. 2 is a schematic diagram showing components of an example server of the system shown in FIG. 1;

FIG. 3 is a diagram showing components of an example of a payment terminal of the system shown in FIG. 1;

FIG. 4 is a flowchart diagram showing example steps of enrollment being executed by the biometric system of FIG. 1;

FIG. 5 is a flowchart diagram showing the interoperation of the components of embodiments of the system for authenticating a biometric request;

FIG. 6 is a schematic diagram of an alternate system for biometric authentication according to certain embodiments;

FIG. 7 is a block diagram of an example payment device of the system shown in FIG. 1;

FIG. 8 is a flowchart diagram showing the interoperation of the components of embodiments of the system for biometric authentication;

FIG. 9a is a diagram showing an example of steps of extracting a fingerprint to generate a template; and

FIG. 9b is a diagram showing an example of steps of comparing a biometric input against a reference template for authenticating a biometric request.

The same numerals represent the same or similar elements throughout the drawings.

### DETAILED DESCRIPTION

Embodiments of the present disclosure will be described, by way of example only, with reference to the drawings. The description and specific examples included herein are intended for purposes of illustration only and are not intended to limit the scope of the present disclosure.

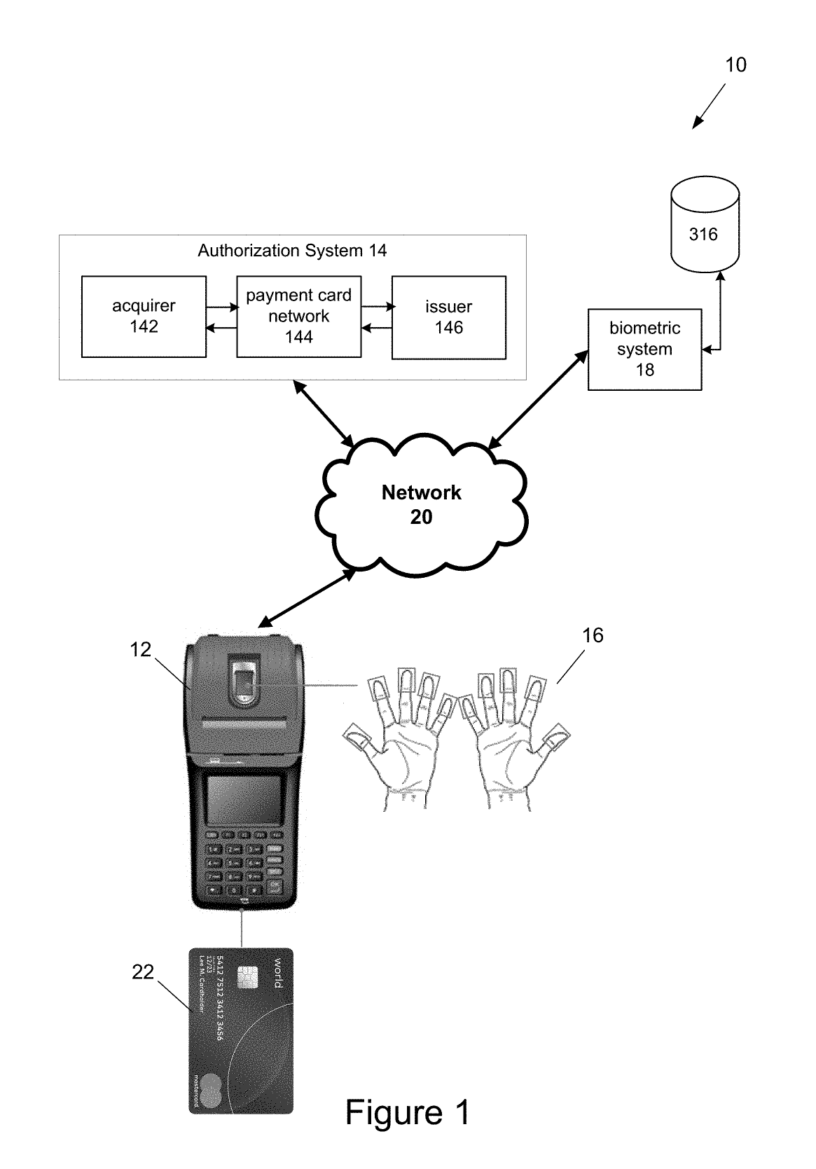

The system 10 shown in FIG. 1 allows the authentication of a biometric request. The system 10 includes the following:
(a) payment terminal 12;
(b) authorization system 14;
(c) cardholder's biometrics 16;
(d) biometric system 18; and
(e) cardholder's payment device 22.

The components of system 10 are in communication via the network 20. The communication network 20 may include the Internet, telecommunications networks and/or local area networks.

The system 10 advantageously provides a more secure manner of biometric authentication for use in authorizing payment transactions. The system 10 provides an additional level of security beyond mere biometric matching against a reference template. Since the person conducting the transaction needs to correctly select which biometric authentication method to use with the transmitted key (e.g., correctly choose from among 10 possible fingerprints, or select iris scanning or facial recognition as the mode of authentication), an additional layer of security is added to the cardholder verification process, thereby reducing the risk of fraudulent transactions.

### Biometric System 18

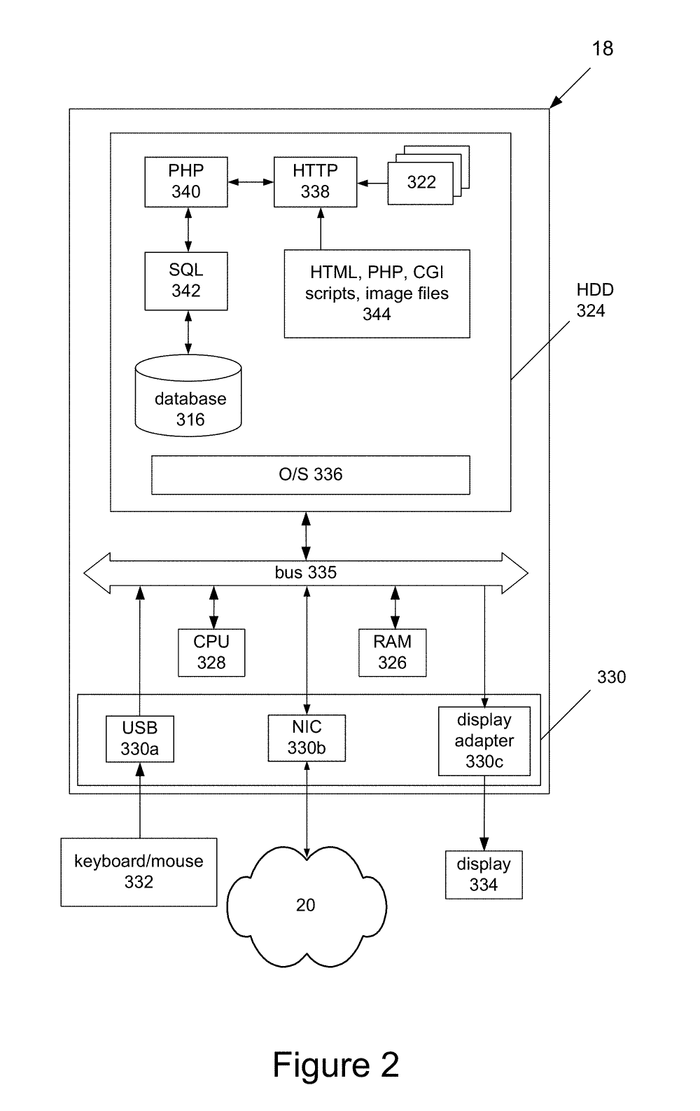

As shown in FIG. 2, the biometric system 18 may comprise a server 18. In some embodiments, the system may comprise multiple servers in communication with each other, for example, over a local area network or a wide-area network, such as the Internet. As described in the preceding section, the biometric system 18 is able to communicate with other components of the system 10 over the wireless communications network 20 using standard communication protocols.

The components of the biometric system 18 can be configured in a variety of ways. The components can be implemented entirely by software to be executed on standard computer server hardware, which may comprise one hardware unit or different computer hardware units distributed over various locations, some of which may require the communications network 20 for communication. A number of the components or parts thereof may also be implemented by application specific integrated circuits (ASICs) or field programmable gate arrays.

In the example shown in FIG. 2, the biometric system 18 is a commercially available server computer system based on a 32 bit or a 64 bit Intel architecture, and the processes and/or methods executed or performed by the biometric system 18 are implemented in the form of programming instructions of one or more software components or modules 322 stored on non-volatile (e.g., hard disk) computer-readable storage 324 associated with the biometric system 18. At least parts of the software modules 322 could alternatively be implemented as one or more dedicated hardware components, such as application-specific integrated circuits (ASICs) and/or field programmable gate arrays (FPGAs).

The biometric system 18 includes at least one or more of the following standard, commercially available, computer components, all interconnected by a bus 335:
(a) random access memory (RAM) 326;
(b) at least one computer processor 328, and
(c) external computer interfaces 330:
   (i) universal serial bus (USB) interfaces 330a (at least one of which is connected to one or more user-interface devices, such as a keyboard, a pointing device (e.g., a mouse 332 or touchpad),
   (ii) a network interface connector (NIC) 330b which connects the computer system to a data communications network, such as the wireless communications network 20; and
   (iii) a display adapter 330c, which is connected to a display device 334, such as a liquid-crystal display (LCD) panel device.

The biometric system 18 includes a plurality of standard software modules, including:
(a) an operating system (OS) 336 (e.g., Linux® or Microsoft® Windows);
(b) web server software 338 (e.g., Apache, available at http://www.apache.org);
(c) scripting language modules 340 (e.g., personal home page or PHP, available at http://www.php.net, or Microsoft® ASP); and
(d) structured query language (SQL) modules 342 (e.g., MySQL, available from http://www.mysql.com), which allows data to be stored in and retrieved/accessed from an SQL database 316.

Advantageously, the database 316 forms part of the computer readable data storage 324. Alternatively, the database 316 is located remote from the server 18 shown in FIG. 2.

Together, the web server 338, scripting language 340, and SQL modules 342 provide the biometric system 18 with the general ability to allow the other components of the system 10 to communicate with the biometric system 18 and in particular to provide data to and receive data from the database 316. It will be understood by those skilled in the art that the specific functionality provided by the biometric system 18 to such users is provided by scripts accessible by the web server 338, including the one or more software modules 322 implementing the method steps performed by the biometric system 18, and also any other scripts and supporting data 344, including markup language (e.g., HTML, XML) scripts, PHP (or ASP), and/or CGI scripts, image files, style sheets, and the like.

The boundaries between the modules and components in the software modules 322 are exemplary, and alternative embodiments may merge modules or impose an alternative decomposition of functionality of modules. For example, the modules discussed herein may be decomposed into submodules to be executed as multiple computer processes, and, optionally, on multiple computers. Moreover, alternative embodiments may combine multiple instances of a particular module or submodule. Furthermore, the operations may be combined or the functionality of the operations may be distributed in additional operations in accordance with the disclosure. Alternatively, such actions may be embodied in the structure of circuitry that implements such functionality, such as the micro-code of a complex instruction set computer (CISC), firmware programmed into programmable or erasable/programmable devices, the configuration of a field-programmable gate array (FPGA), the design of a gate array or full-custom application-specific integrated circuit (ASIC), or the like.

Each of the blocks of the flow diagrams of the method steps of the biometric system 18 may be executed by a module (of software modules 322) or a portion of a module. The method steps may be embodied in a non-transient machine-readable and/or computer-readable medium for configuring a computer system to execute the method. The software modules may be stored within and/or transmitted to a computer system memory to configure the computer system to perform the functions of the module.

The biometric system 18 normally processes information according to a program (a list of internally stored instructions, such as a particular application program and/or an operating system) and produces resultant output information via input/output (I/O) devices 330. A computer process typically includes an executing (running) program or portion of a program, current program values and state information, and the resources used by the operating system to manage the execution of the process. A parent process may spawn other child processes to help perform the overall functionality of the parent process. Because the parent process specifically spawns the child processes to perform a portion of the overall functionality of the parent process, the functions performed by child processes (and grandchild processes, etc.) may sometimes be described as being performed by the parent process.

The biometric system 18 may be provided for by an entity of the authorization system 14 e.g. the acquirer 142, the payment card network 144 or the issuer 146. The biometric system 18 may also be provided for by a third party system.

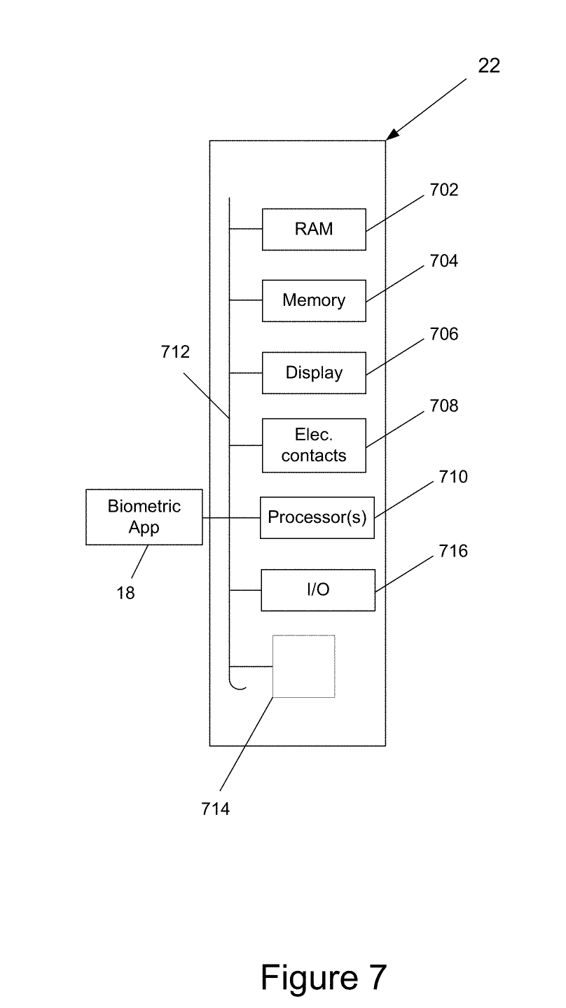

In some embodiments, the biometric system 18 may be at least partly embodied as application software 18 being executed on the payment device 22 shown in FIG. 7.

### Authorization System 14

The authorization system 14 is able to communicate with the payment terminal 12 through standard communication protocols provided for by communications network 20, in order to receive requests to authorize transactions.

For example, the authorization system 14 may comprise an acquirer system 142 (which may in turn comprise a core banking system in communication with an acquirer processor system), a payment network 144 (such as Mastercard®, Visa® or China Unionpay®) and an issuer system 146 (which may comprise a core banking system and an issuer processor system). In some cases, the acquirer 142 and issuer 146 may be the same entity, for example, if the payment network is a three-party payment network (such as American Express® or Discover®) or other closed-loop payment systems.

The authorization system 14 may receive the payment authorization request via the acquirer system 142, which routes the request via the payment network 144 to the issuer system 146 in a manner known in the art. The request may be formatted according to the ISO 8583 standard, for example, and may comprise a primary account number (PAN) of the payment instrument being used for the transaction, a merchant identifier (MID), and an amount of the transaction, as well as other transaction-related information as will be known by those skilled in the art. The issuer system 146 receives the request, applies authorization logic to approve or decline the request, and sends an authorization response (approve or decline, optionally with a code indicating the reason for the decline) back to the acquirer system 142 via the payment network 144 in known fashion. The acquirer system 142 then communicates the authorization response to the payment terminal 12.

Alternatively, in some embodiments, the authorization system 14 may receive the payment authorization request via the issuer system 146, which approves or declines the request (which again may be in ISO 8583 format, and comprise a PAN, MID, transaction amount, etc.) and sends a response directly back to the payment terminal 12.

In addition to processing requests for payment in which funds are actually transferred from the cardholder's account (maintained in the issuer's core banking system) to the merchant's account (maintained in the acquirer's core banking system), the authorization system 14 may process a pre-authorization (or “pre-auth”) request, in which funds are not transferred on approval of the request, but are instead placed on hold. The pre-auth can later be completed, for example, by the payment terminal 12, in order to release the funds. Alternatively, the pre-auth can be cancelled, thus effectively cancelling the transaction.

### Payment Terminal 12

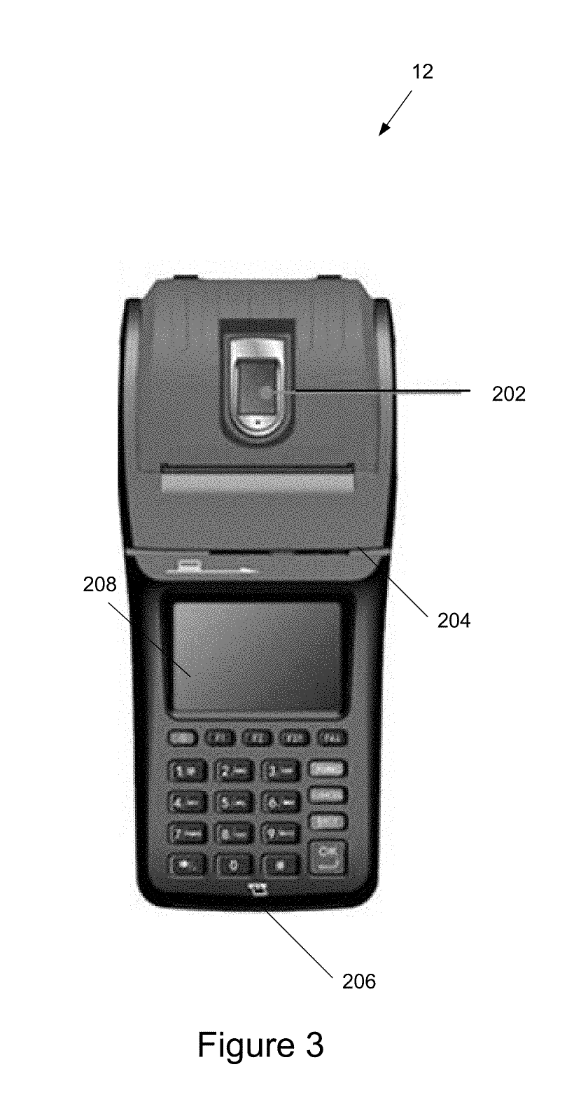

The payment terminal 12 shown in FIG. 3 is a device which allows merchants to generate electronic payment requests. In this example, the payment terminal 12 includes at least one microprocessor, a memory, a display 208, an external interface for communicating with communications network 20 and card reading interfaces 206 and 204. In some embodiments, the payment terminal 12 further includes a biometric sensor, such as a fingerprint sensor 202. It may also include and/or be interfaced with other biometric sensors, such as an iris scanner, a sub-dermal imaging device, a voiceprint recognition device, and so on.

In other embodiments, the payment terminal 12 is a mobile computer device, such as a smart phone, a personal data assistant (PDA), a palm-top computer, and multimedia Internet enabled cellular telephones.

It should be recognized that FIG. 3 is merely exemplary and in one or more exemplary embodiments, the functions described herein may be implemented in hardware, software, firmware, or any combination thereof. If implemented in software, the functions may be stored on or transmitted over as one or more instructions or code encoded on a non-transitory computer-readable medium. Non-transitory computer-readable media comprises both computer storage media and communication media including any medium that facilitates transfer of a computer program from one place to another. A storage medium may be any available medium that can be accessed by a computer.

The payment terminal 12 is capable of interfacing with a payment device via the card reading interface, for example, by way of magnetic stripe 204, EMV 206 or near field communication (NFC) technology. The payment device may be embodied by one or more of the following:
(a) a payment card;
(b) a credit card;
(c) a debit card;
(d) a store card;
(e) a gift card;
(f) a payment token;
(g) a wearable device; and
(h) a mobile computing device.

In this embodiment, the payment terminal 12 includes a fingerprint sensor 202 for reading a cardholder's fingerprint. The sensor 202 may be a touch or swipe finger sensor. A touch sensor captures the full picture of the fingerprint whilst a swipe sensor will capture sub-images of the fingerprint and combines the sub-images into a single composite image using an image composition algorithm.

In other embodiments, the payment terminal 12 includes a biometric sensor 202 including one or more of the following:
(a) a retina scanner;
(b) a microphone capable of voice recognition;
(c) a camera capable of facial recognition;
(d) a sensor capable of hand geometry biometrics;
(e) a sensor capable of finger geometry biometrics;
(f) an iris scanner; and
(g) signature or handwriting recognition using a digitizing tablet or capacitive touchscreen, for example.

In certain embodiments, the biometric sensor 202 may be external to the payment terminal 12 and may communicate with the components of system 10 via network 20.

In other embodiments, the payment terminal 12 may, at least in part, provide for the biometric system 18. Some components of the biometric system 18 may be external to the payment terminal 12. For example, the database 316 may be an external database, e.g., on the cloud, accessible by payment terminal 12 using communications network 20.

In certain embodiments, the payment terminal 12 allows the merchant or his or her employee to manually enter the total transaction amount. In another embodiment, the payment terminal 12 is preferably coupled to the merchant's point-of-sale (POS) system. The POS system stores inventory and pricing information and allows the merchant to automatically calculate the total amount due which is sent to the payment terminal 12 to put it in readiness to receive the card details.

The payment terminal 12 may be provided to the merchant and maintained by a third party provider, such as an acquirer 142. The payment terminal 12 is able to communicate with the authorization system 14 through standard communication protocols provided for by communications network 20.

The operational steps for a preferred embodiment of the disclosure are described in further detail below.

### Payment Device 22

The payment device 22 may be a payment card, such as a credit card or a debit card, as shown in FIG. 1. Other embodiments of the payment device 22 include a mobile computing device executing application software 18, for example a Digital Wallet, such as Apple Pay™, Samsung Pay™ or MasterPass™.

As shown in FIG. 7, the payment device 22 includes the following components in electronic communication via a bus 712:
(a) at least one processor 710;
(b) volatile memory (RAM) 702;
(c) I/O component 716;
(d) non-transitory data storage 704;
(e) display 706; and
(f) electrical contacts 708 that allow communication between the payment device and external devices or systems.

Although the components depicted in FIG. 7 represent physical components, FIG. 7 is not intended to be a hardware diagram. Thus, many of the components depicted in FIG. 7 may be realized by common constructs or distributed among additional physical components. Moreover, it is certainly contemplated that other existing and yet-to-be developed physical components and architectures may be utilized to implement the functional components described with reference to FIG. 7.

In general, the non-transitory data storage 704 (also referred to as non-volatile memory) functions to store (e.g., persistently store) data and executable code. In some embodiments, for example, the non-volatile memory 704 comprises bootloader code, modem software, operating system code, file system code, and code to facilitate the implementation components, known to those of ordinary skill in the art, which are not depicted nor described for simplicity.

In many implementations, the non-volatile memory 704 is realized by flash memory (e.g., NAND or ONENAND memory), but it is certainly contemplated that other memory types may be utilized as well. Although it may be possible to execute the code from the non-volatile memory 704, the executable code in the non-volatile memory 704 is typically loaded into RAM 702 and executed by one or more of the N processing components 710. The N processing components 710 in connection with RAM 702 generally operate to execute the instructions stored in non-volatile memory 704.

In another embodiment, the payment device 22 further includes an integrated biometric sensor 714. In the described embodiments, the sensor is a fingerprint scanner; however other types of sensors capable of acquiring biometric information of the purchaser could be used in other embodiments. Other types of biometric sensors capable of being integrated into the payment device 22 will be apparent to those skilled in the art in light of this disclosure.

The powered components of the payment device 22, the processor and volatile memory, for example, are powered by the payment terminal 12 when contact is established with its electrical contacts 708. Other means of powering the payment device 22 is possible in other embodiments, for example, via NFC communication between the payment terminal 12 and payment device 22. These methods are known to those skilled in the art and will not be discussed in further detail.

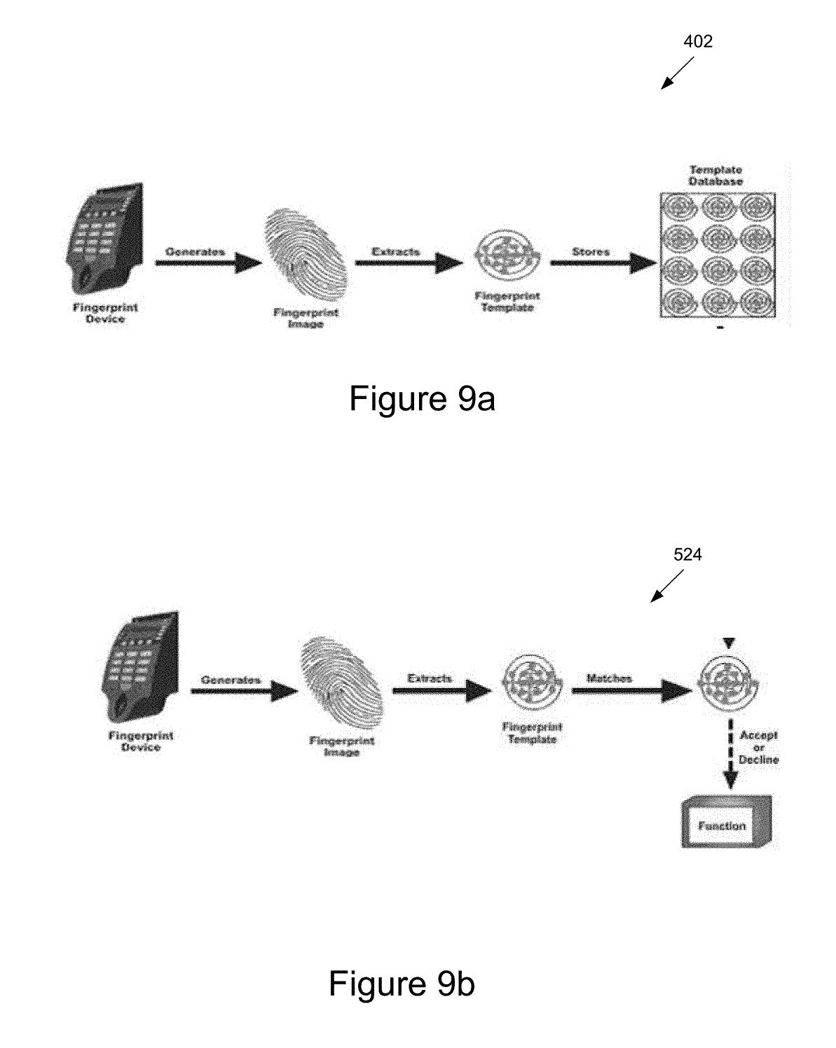

In some embodiments, the payment device 22 is configured to store cardholder data in non-transitory data storage 704. Cardholder data may include reference biometric template(s) and key(s) associated with the reference biometric template(s). In other embodiments, the payment device 22 is capable of randomized selection of a key and performing biometric feature matching as shown in FIG. 9b. This embodiment is further described in greater detail below.

The I/O component 716 comprises N transceiver chains, which may be used for communicating with external devices. Each of the N transceiver chains may represent a transceiver associated with a particular communication scheme. The I/O component 716 is also adapted to effect payments contactlessly, or otherwise. For example, I/O component 716 is able to effect contactless payment using Near-Field Communications (NFC) according to the EMV standard. Digital payment methods based on the EMV standard may include Apple Pay™, or MasterPass™, for example.

It should be recognized that FIG. 7 is merely exemplary and in one or more exemplary embodiments, the functions described herein may be implemented in hardware, software, firmware, or any combination thereof. If implemented in software, the functions may be stored on or transmitted over as one or more instructions or code encoded on a non-transitory computer-readable medium 704. Non-transitory computer-readable medium 704 comprises both computer storage medium and communication medium including any medium that facilitates transfer of a computer program from one place to another. A storage medium may be any available medium that can be accessed by a computer.

### Enrollment Process 400

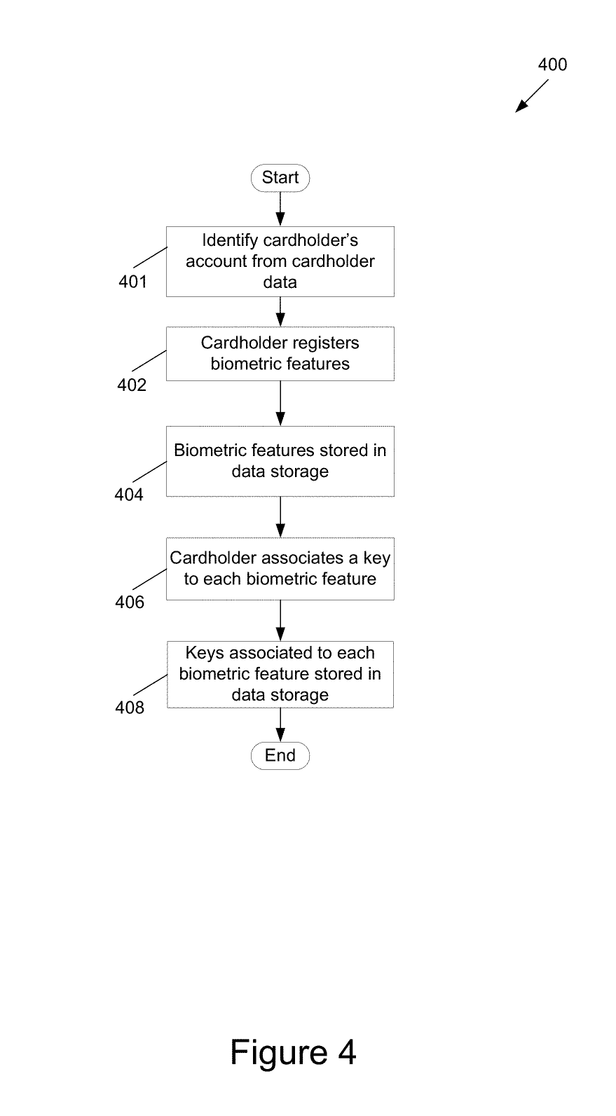

Prior to effecting a payment transaction by biometric authentication, the cardholder's biometric data 16 first needs to be enrolled. FIG. 4 shows the enrollment process 400 for enrolling a cardholder's biometric data 16.

In this embodiment, the cardholder performs enrollment process 400 at the financial institution which issued the payment card, i.e., the issuer institution. In other embodiments, the enrollment may be performed via a phone call or through the cardholder's mobile computer device. In this embodiment, the cardholder's biometric data 16 consists of fingerprints.

In this embodiment, the biometric system 18 executes, at least in part, the enrollment process 400. The biometric system 18 receives cardholder data which may include one or more of the following:
(a) data representing a payment card number (PAN); and
(b) data representing an identifier associated with the cardholder.

At step 401, the biometric system 18 identifies the cardholder's account using the received cardholder data. At step 402, the biometric system 18 registers biometric features. In this example, the cardholder registers his or her biometric features by applying his or her finger on the fingerprint sensor of a fingerprint device as shown in FIG. 9a. It will be appreciated that different biometric enrollment processes will apply to different types of biometric. The fingerprint device generates a fingerprint image. Features of the fingerprint image are extracted to generate a fingerprint template. At step 404, the biometric system stores the fingerprint template as part of a template database associated with the cardholder's account in data storage 316. At step 406, the biometric system 18 requests for the cardholder to assign a key to be associated with the biometric feature which was enrolled. The key acts as a visual cue to the cardholder to select an appropriate biometric authentication method at the time of making a transaction. The biometric system 18 may generate for display a list of predefined alphanumeric strings or images from among a library of such strings or images, for cardholder selection. In another embodiment, the biometric system 18 requests the cardholder to input a string of alphanumeric characters of a predefined length. At step 408, the biometric system 18 stores, in data storage 316 associated with the cardholder's account, the key associated with the biometric feature.

In the above-mentioned embodiment, a single key is associated with a single biometric feature. The key may be displayed during a cardholder verification process as a security measure.

In other embodiments, one or more biometric features are enrolled and associated with one or more keys. In this embodiment, an indexed array of keys and corresponding biometric features are enrolled and stored in data storage 316 of the biometric system 18. This embodiment will require the cardholder to remember the association between the one or more keys with the one or more biometric features. In other embodiments, a series of different keys may be mapped to a single biometric feature, instead of one key per biometric feature.

In some embodiments, different biometric methods may be associated with each key. For example, each key from the series of keys may be associated to one of the following biometric features:
(a) a fingerprint scan;
(b) a retina scan;
(c) voice recognition;
(d) facial recognition;
(e) hand geometry biometrics;
(f) finger geometry biometrics;
(g) an iris scan; and
(h) signature or handwriting recognition.

In other embodiments, the one or more keys and/or the biometric features are stored in data storage of the payment device 22 instead of the biometric system 18. The payment device 22 may be one of the following:
(a) a mobile device executing a digital wallet application;
(b) a payment token;
(c) a wearable device;
(d) a credit card; and
(e) a debit card.

In certain embodiments, the payment device 22 further includes:
(a) non-transitory data storage; and
(b) a data transfer interface to allow the exchange of data between the data storage of the payment device and a payment terminal.

The data transfer interface of the payment device 22 allows exchange of data including one or more of the following:
(a) a PAN;
(b) an identifier associated with the cardholder;
(c) one or more keys; and
(d) one or more biometric reference biometric templates associated with the one or more keys.

The digital wallet is embodied by an application running on a mobile computer device. The one or more keys and/or the biometric features may be stored in data storage of the mobile computer device itself or accessible through a digital wallet provider system.

### Biometric Method for Authenticating a Biometric Request 500

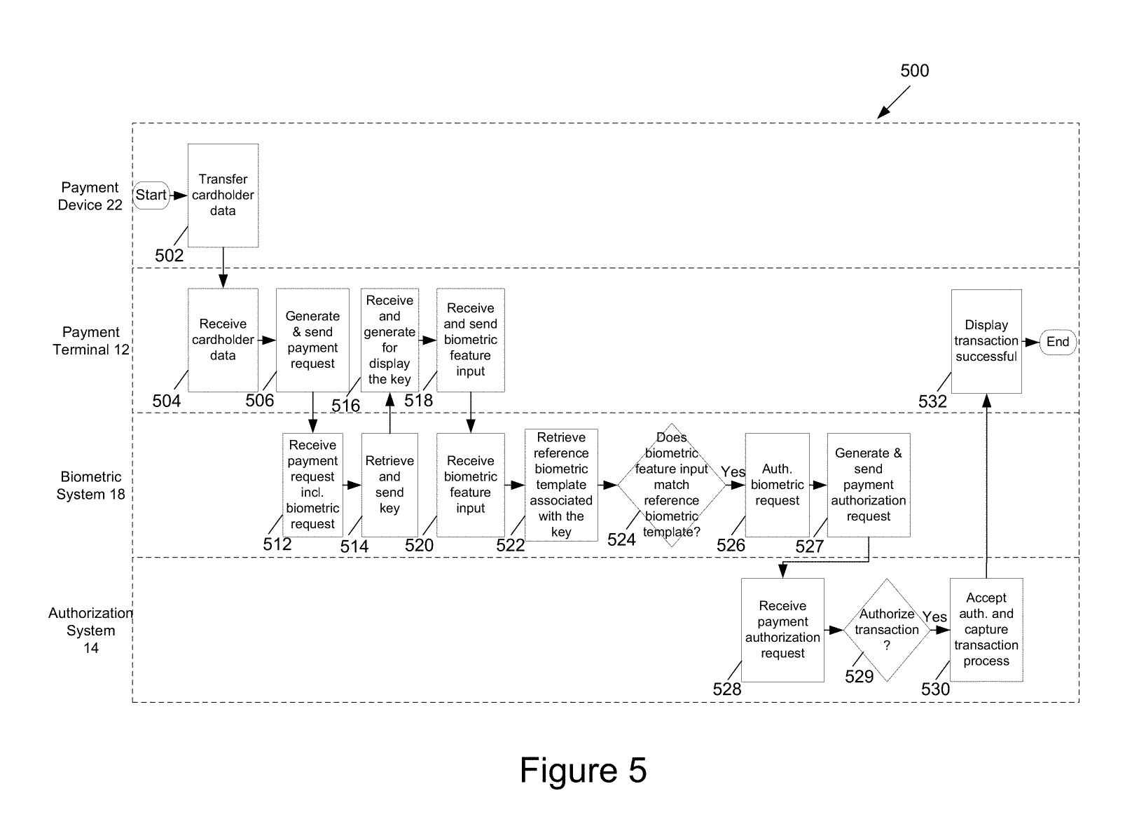

The interoperations of the components of system 10, for authenticating a biometric request, is hereafter described by way of non-limiting example with reference to the method 500 shown in FIG. 5.

At step 502, the payment device 22 transfers data representing cardholder data stored thereon to the payment terminal 12. The transfer of data representing cardholder data may be effected in a number of different ways depending on the payment device 22 including one or more of the following:
(a) a magnetic stripe;
(b) an EMV chip; and
(c) contactless technology, for example, through induction technology, radio frequency identification or near field communication.

At step 504, the payment terminal 12 receives cardholder data from the payment device 22. Cardholder data includes information used to identify the cardholder and may include one or more of the following:
(a) a payment card number (PAN); and
(b) an identifier associated with the cardholder.

Cardholder data received from the payment device 22 may further include one or more of the following:
(a) a key; and
(b) a reference biometric template associated with the key.

The payment terminal 12 receives payment information, for example, the total payment amount. This may be by way of a manual entry by the merchant or in another embodiment, the payment terminal 12 is in communication with a merchant's point-of-sale (POS) system and receives the total payment amount from the POS system.

At step 506, the payment terminal 12 generates a payment request. If the payment request includes a biometric request, the payment terminal 12 sends the payment request to the biometric system 18. Biometric authentication may be triggered based on a payment limit threshold, whereby any payment transactions exceeding a limit of $100, for example, may require biometric authentication. Another trigger may be if the risk of fraudulent transactions is high. For example, the fraud risk may be assessed based on a threshold limit for a fraud score. The fraud score may be based on the likelihood of the transaction being fraudulent and may be generated from factors, such as transaction type, merchant type, country of origin of the transaction, and so on.

At step 512, the biometric system 18 receives a payment request from the authorization system 14, the request including cardholder data and a biometric request. At step 514, the system 18 retrieves, from data storage 316, a key associated with the cardholder data and sends the key to payment terminal 12. In another embodiment, the key is received at step 512 as part of the payment request from the payment terminal 12.

In certain embodiments, the key is one of a plurality of keys which comprise an indexed array of keys associated with the cardholder data, wherein said indexed array of keys correspond with an indexed array of reference biometric templates. In this embodiment, the biometric system 18 further performs the steps of:
(a) retrieving the size of the indexed array of keys;
(b) applying a randomized selection of a number between zero and the size of indexed array of keys to obtain a random index number;
(c) temporarily storing, in data storage, data representing the random index number; and
(d) retrieving a key associated with the random index number.

The key may be data representing a string of text, an image or a sound, for example.

At step 516, the payment terminal 12 generates, on display 208, message data representing the key received from the biometric system 18. The payment terminal 12 also generates, on display 208, message data representing a request for purchaser's biometric feature input via the biometric sensor 202. In the case of the biometric feature input being a fingerprint, the purchaser, upon seeing the key on display 208, applies his or her finger associated with the displayed key on the biometric sensor 202. In other embodiments, biometric data is from one or more of the following:
(a) a retina scanner;
(b) a microphone capable of voice recognition;
(c) a camera capable of facial recognition;
(d) a sensor capable of hand geometry biometrics;
(e) a sensor capable of finger geometry biometrics;
(f) an iris scanner; and
(g) signature or handwriting recognition using a digitizing tablet or capacitive touchscreen, for example.

In some embodiments, more than one type of biometric sensors may be used. In this embodiment, each key is associated with a type of biometric sensor and a reference biometric feature. This embodiment would result in a higher level of security compared to just one type of biometric sensor.

At step 518, the payment terminal 12 receives data representing biometric input from a purchaser and sends message data to the biometric system 18. In the embodiment with multiple biometric sensors, the message data sent to the biometric system 18 further includes the type of biometric input, e.g., fingerprint scan or retina scan.

At step 520, the biometric system 18 receives message data representing the biometric feature input of the purchaser. At step 522, the biometric system 18 retrieves, from data storage 316, a reference biometric template associated with the key. In another embodiment, the reference biometric template associated with the key is received at step 512 as part of the payment request from the payment terminal 12. In the embodiment with multiple biometric sensors, the biometric system 18 also retrieves, from data storage 316, the type of biometric input associated with the key. The biometric system 18 then checks if the received biometric input type is the same as the retrieved type of biometric input associated with the key.

At step 524, the biometric system compares the data representing biometric input from the purchaser with the reference biometric template associated with the key, as shown in FIG. 9b.

In certain embodiments, if the biometric input received from the payment terminal is raw data from a sensor, the biometric system performs the step of generating a template from the biometric input by performing the steps of:
(a) preprocessing the data from a sensor;
(b) extracting the features of preprocessed data from a sensor; and
(c) generating a template from extracted features for comparing with the reference biometric template associated with the key.

In other embodiments, one or more of the steps listed above may be performed by a different entity, the payment terminal 12 or authorization system 14, for example. Any suitable methods for preprocessing, performing feature extraction and template generation which are known in the art may be used.

In certain embodiments, step 524 further includes the step of generating a matching score indicating how closely said data representing biometric input from the purchaser matches the reference biometric template associated with the key. The biometric system successfully authenticates the biometric authentication request if the matching score is within a predefined threshold (e.g., if the matching score is a percentage, 80% or better, 85% or better, or 90% or better).

If the data representing biometric input from the purchaser matches with the reference biometric template associated with the key, then the biometric system 18, at step 526, authenticates the request. The biometric system 18 then performs the authentication step 527 of:
(a) generating payment authorization request message data including an indication that the biometric input from the purchaser matches with the reference biometric template associated with the key; and
(b) sending, to authorization system 14, the payment authorization message data including data representing successful biometric authentication.

If the data representing biometric input from the purchaser does not match with the biometric template associated with the key, then the biometric system 18 performs the authentication steps of:
(a) generating payment authorization request message data including data representing unsuccessful biometric authentication from template matching results; and
(b) sending, to authorization system 14, the payment authorization message data including data representing unsuccessful biometric authentication.

In certain embodiments, as part of step 527, the payment terminal 12 sends message data indicating biometric authentication status to one or more of the following:
(a) a payment network system; and
(b) an issuer processor system.

At step 528, the authorization system 14 receives the payment authorization message data from the biometric system 18. At step 529, the authorization system 14 processes the payment authorization request including the biometric authentication status indicating successful or unsuccessful authentication. If the transaction is authorized by the authorization system 14, step 530 is performed whereby the payment transaction is captured and message data is generated and sent to the payment terminal 12 indicating successful authorization of the payment. At step 532, the payment terminal 12 receives message data from the authorization system 14 and generates for display 208 message data representing status of the transaction, i.e., transaction is successful or transaction is declined.

In certain embodiments, the payment terminal 12 is part of the biometric system 18.

### Biometric Method for Authenticating a Biometric Request 600

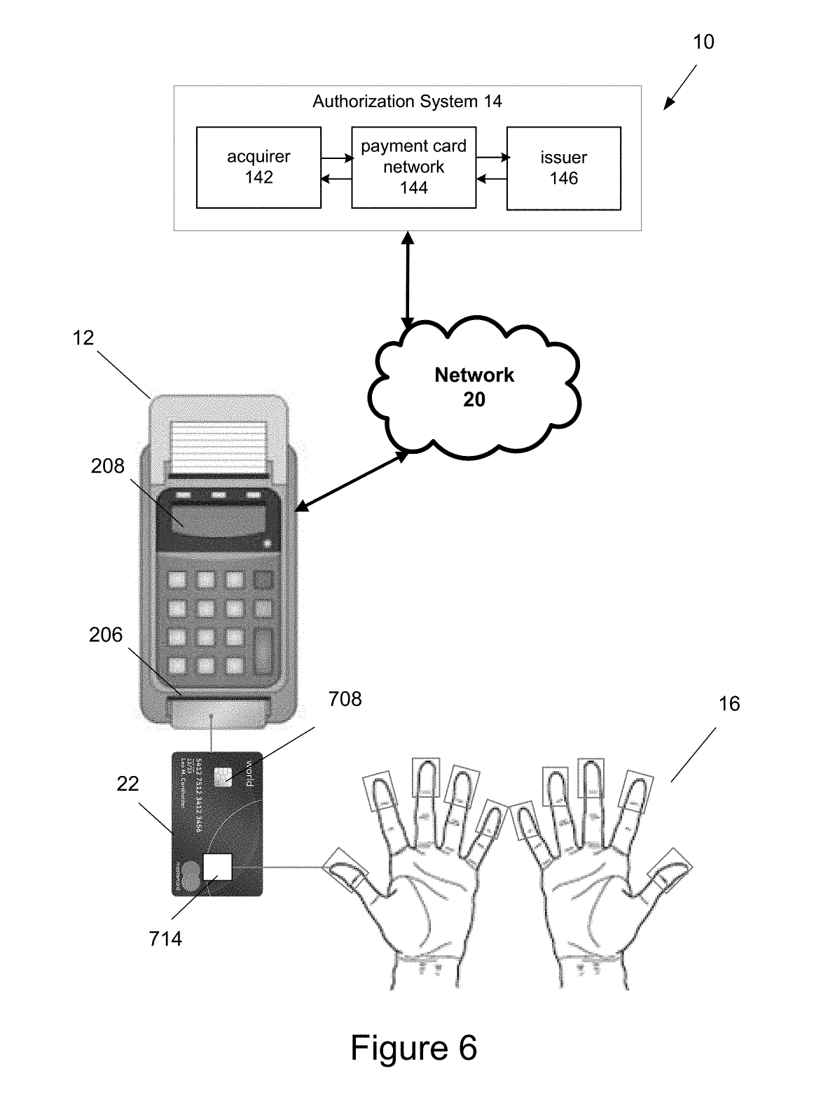

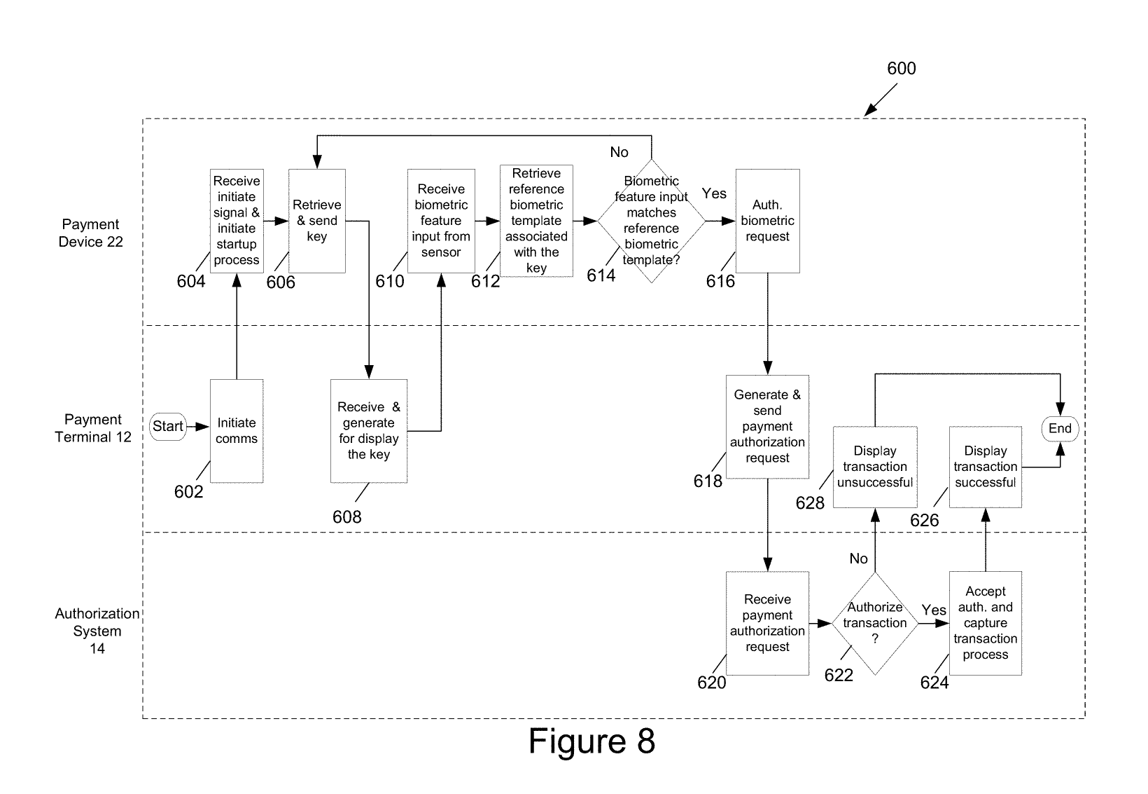

An alternative embodiment of system 10 is shown in FIG. 6. The payment card 22 shown in FIG. 6 is shown in further detail in FIG. 7. The interoperations of the components of system 10 as shown in FIG. 6, for authenticating a biometric request, is hereafter described by way of non-limiting example with reference to the method 600 shown in FIG. 8. In certain embodiments, the biometric system 18 may at least in part, be provided for by the payment terminal 12. In some embodiments, the biometric system 18 may be embodied as an application program 18 being executed on the payment device 22 shown in FIG. 7 wherein the database 316 is provided for, at least in part, by memory 704.

The payment device 22 may be embodied by a payment card such as a credit card or debit card. In other embodiments, the payment device may be a mobile computing device configured to initiate a payment, for example, using a Digital Wallet, e.g., ApplePay™ SamsungPay™ or MasterPass™.

To initiate a payment, a payment device 22 is brought in contact with the payment terminal 12. For example, for a payment transaction using the electrical contacts 708, the payment device 22 is inserted into EMV card interface 206. At step 602, the payment terminal 12 initiates communication with the payment device 22. In some embodiments, this step may include the payment terminal 12 supplying power to the payment device 22. The step 602 may further include sending a request for biometric authentication to the payment device 22.

In other embodiments, a transfer of data representing cardholder data from the payment device 22 to the payment terminal 12 may be effected as part of the initiation process. This may be effected in a number of different ways depending on the communication components of the payment device 22 including one or more of the following:
(a) a magnetic stripe;
(b) an EMV chip; and
(c) contactless technology, for example, through induction technology, radio frequency identification or near field communication.

At step 604, the payment device 22 receives the communication initiation signal from the payment terminal 12 and initiates a startup process.

In certain embodiments, the communication initiation process may include transferring cardholder data for identifying the cardholder including:
(a) a payment card number (PAN); or
(b) an identifier associated with the cardholder.

Cardholder data received by the payment terminal 12 from the payment device 22 may further include one or more of the following:
(a) a key; and
(b) reference biometric template associated with the key.

At step 606, the payment device retrieves, from data storage, a key and sends the key to the payment terminal 12.

In certain embodiments, the key is one of a plurality of keys which comprise an indexed array of keys, wherein said indexed array of keys correspond with an indexed array of reference biometric templates. In this embodiment, the payment device 22 further performs the steps of:
(a) retrieving the size of the indexed array of keys;
(b) applying a randomized selection of a number between zero and the size of indexed array of keys to obtain a random index number;
(c) temporarily storing, in data storage, data representing the random index number; and
(d) retrieving a key associated with the random index number.

The payment device 22 then sends the retrieved key from data storage to the payment terminal 12. In another embodiment, the key is retrieved from a third party system.

At step 608, the payment terminal 12 receives and generates on display 208, message data representing the key received from payment device 22. The step 608 may further include the step of the payment terminal 12 generating message data on display 208 requesting for the purchaser to input biometric feature on biometric sensor 714. At step 610, the payment device 22 receives data representing a purchaser's biometric feature input from a biometric sensor 714, which is part of the payment device 22. The biometric sensor 714 may be external to both the payment terminal 12 and the payment device 22. In another embodiment the biometric sensor 202 is part of the payment terminal 12 as shown in FIG. 3.

In the case of the biometric feature input being a fingerprint, the purchaser, upon seeing the key on display 208, applies his or her finger associated with the displayed key on the biometric sensor 714. In other embodiments, biometric data is from one or more of the following:
(a) a retina scanner;
(b) a microphone capable of voice recognition;
(c) a camera capable of facial recognition;
(d) a sensor capable of hand geometry biometrics;
(e) a sensor capable of finger geometry biometrics;
(f) an iris scanner; and
(g) signature or handwriting recognition using a digitizing tablet or capacitive touchscreen, for example.

In some embodiments, more than one biometric sensors are part of the payment terminal 12, or at least in communication with the payment terminal 12. In this embodiment, after capturing the purchaser's biometric data, the payment terminal 12 also captures data indicating the type of biometric sensor used.

At step 612, the payment device 22 retrieves from memory 704 a reference biometric template associated with the key. In another embodiment, the reference biometric template associated with the key is retrieved from a third party system. In some embodiments where more than one biometric sensors are part of the payment terminal 12, the type of biometric sensor associated with the key is also retrieved. The payment device 22 then compares the retrieved type of biometric sensor associated with the key against the captured data indicating the type of biometric sensor used.

At step 614, the payment device 22 compares the data representing biometric input from the purchaser with the reference biometric template associated with the key, as shown in FIG. 9b.

In certain embodiments, if the biometric input received from the biometric sensor is raw data from a sensor, the payment device 22 performs the step of generating a template from the biometric input by performing the steps of:
(a) preprocessing the data from a sensor;
(b) extracting the features of preprocessed data from a sensor; and
(c) generating a template from extracted features for comparing with the reference biometric template associated with the key.

In other embodiments, one or more of the steps listed above may be performed by a different entity, the payment terminal 12 or authorization system 14, for example. These methods are known in the art and as such, are not discussed with great detail.

In certain embodiments, step 614 further includes the step of generating a matching score indicating how closely said data representing biometric input from the purchaser relates with the reference biometric template associated with the key. The payment device 22 successfully authenticates the biometric authentication request if the matching score is within a predefined threshold.

If the data representing biometric input from the purchaser matches with the reference biometric template associated with the key, the payment device 22 performs step 616. Otherwise, the payment device loops back to step 606 as described above.

At step 616, if the data representing biometric input from the purchaser matches with the reference biometric template associated with the key, then the payment device 22 performs the authentication steps of:
(a) generating a payment authorization request message data including an indication that the biometric input from the purchaser matches with the reference biometric template associated with the key; and
(b) sending, to the payment terminal 12, the payment authorization message data including data representing successful biometric authentication.

In certain embodiments, the message data may include data representing the cardholder, such as a PAN or identifier associated with the cardholder for payment authorization by the authorization system 14.

If the data representing biometric input from the purchaser does not match with the biometric template associated with the key, then the payment device 22 performs the authentication steps of:
(a) generating a payment authorization request message data including data representing unsuccessful biometric authentication from template matching results; and
(b) sending, to payment terminal 12, the payment authorization message data including data representing unsuccessful biometric authentication.

At step 618, the payment terminal 12 receives message data representing successful biometric authentication. The payment terminal 12 then generates and sends a payment authorization request to the authorization system 14, payment authorization request including cardholder data, data representing biometric authentication status and transaction information. The transaction information includes, for example, the total payment amount. This may be a manual entry by the merchant or the payment terminal 12 is in communication with a merchant's point-of-sale (POS) system and receives the total payment amount from the POS system.

At step 620, the authorization system 14 receives the payment authorization message data from the payment terminal 12. At step 622, the authorization system 14 processes the payment authorization request including the biometric authentication status indicating successful authentication.

If the transaction is authorized, the authorization system 14 performs the step of 624, whereby the payment transaction is captured and message data is generated and sent to the payment terminal 12 indicating successful authorization of the payment. At step 626, the payment terminal 12 receives message data from the authorization system 14 and generates for display 208 message data representing status of the transaction, i.e., transaction is successful or transaction is declined.

If the transaction is not authorized, the authorization system 14 generates message data indicating unsuccessful authorization of the payment and sends the message to the payment terminal 12. At step 628, the payment terminal 12 receives message data from the authorization system 14 and generates for display 208 message data representing status of the transaction, i.e., transaction is unsuccessful.

In another embodiment, the biometric authentication method may be provided for, at least in part, by the payment terminal 12, wherein the payment terminal 12 is for authenticating a transaction for a purchaser, comprising one or more processors in communication with a biometric sensor, a display and non-transitory data storage having instructions stored thereon which, when executed by the processor or processors, configure the payment terminal 12 to perform the steps of:
(a) receiving cardholder data from the payment device 22;
(b) retrieving, from data storage, a key associated with the cardholder data;
(c) generating on display 208, message data representing the key;
(d) receiving, from the biometric sensor 202, data representing biometric input from the purchaser;
(e) retrieving, from data storage, the reference biometric template associated with the key;
(f) comparing said data representing biometric input from the purchaser with the reference biometric template associated with the key;
(g) if said data representing biometric input from the purchaser matches with the reference biometric template associated with the key, then performing the biometric authentication steps of:
   (i) generating message data representing payment authorization request including data representing successful biometric authentication from template matching results; and
   (ii) sending, to an authorization system 14, the message data for payment authorization.

Throughout this specification, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference to any prior art in this specification is not, and should not be taken as, an acknowledgment or any form of suggestion that the prior art forms part of the common general knowledge.

With that said, and as described, it should be appreciated that one or more aspects of the present disclosure transform a general-purpose computing device into a special-purpose computing device (or computer) when configured to perform the functions, methods, and/or processes described herein. In connection therewith, in various embodiments, computer-executable instructions (or code) may be stored in memory of such computing device for execution by a processor to cause the processor to perform one or more of the functions, methods, and/or processes described herein, such that the memory is a physical, tangible, and non-transitory computer readable storage media. Such instructions often improve the efficiencies and/or performance of the processor that is performing one or more of the various operations herein. It should be appreciated that the memory may include a variety of different memories, each implemented in one or more of the operations or processes described herein. What's more, a computing device as used herein may include a single computing device or multiple computing devices.

In addition, the terminology used herein is for the purpose of describing particular exemplary embodiments only and is not intended to be limiting. As used herein, the singular forms “a,” “an,” and “the” may be intended to include the plural forms as well, unless the context clearly indicates otherwise. And, again, the terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

It is also noted that none of the elements recited in the claims herein are intended to be a means-plus-function element within the meaning of 35 U.S.C. § 112(f) unless an element is expressly recited using the phrase “means for,” or in the case of a method claim using the phrases “operation for” or “step for.”

Again, the foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A biometric system for authenticating a biometric request received from a payment terminal, comprising one or more processors in communication with non-transitory data storage having instructions stored thereon which, when executed by the processor or processors, configure the system to:
receive a payment request from the payment terminal, the payment request including cardholder data and a biometric authentication request;
retrieve, from data storage, a key associated with the cardholder data;
send, to the payment terminal, message data representing said key;
receive, from the payment terminal, data representing biometric input from a purchaser;
retrieve, from data storage, a reference biometric template associated with the key;
compare said data representing biometric input from the purchaser with the reference biometric template associated with the key;
responsive to a determination that said data representing biometric input from the purchaser matches with the reference biometric template associated with the key:
generate message data representing a payment authorization request including an indication that the biometric input from the purchaser matches with the reference biometric template associated with the key; and
send, to an authorization system, the message data.

2. The biometric system of claim 1, wherein the system is further configured to, in said comparing, generate a matching score indicating how closely said data representing biometric input from the purchaser matches the reference biometric template associated with the key.

3. The biometric system of claim 2, wherein the biometric system successfully authenticates the biometric authentication request responsive to a determination that the matching score is within a predefined threshold.

4. The biometric system of claim 1, wherein the payment terminal is part of the biometric system.

5. The biometric system of claim 1, wherein when the biometric input received from the payment terminal is data from a sensor, the biometric system is configured, in connection with generating a template from the biometric input, to:
preprocess the data from a sensor;
extract the features of preprocessed data from a sensor; and
generate a template from extracted features for comparing with the reference biometric template associated with the key.

6. The biometric system of claim 1, wherein said key is one of a plurality of keys forming part of an indexed array of keys associated with the cardholder data, wherein said indexed array of keys corresponds with an indexed array of reference biometric templates.

7. The biometric system of claim 6, wherein the biometric system is further configured to:
retrieve the size of the indexed array of keys;
apply a randomized selection of a number between zero and the size of indexed array of keys to obtain a random index number;
temporarily store, in data storage, data representing the random index number; and
retrieve a key associated with the random index number.

8. The biometric system of claim 1, wherein the system is configured to obtain data representing biometric input from the purchaser and the reference biometric template associated with the key from one or more of the following:
a fingerprint scanner;
a retina scanner;
a microphone configured to record sounds for voice recognition;
a camera configured to capture images for facial recognition;
a sensor configured for hand geometry biometrics;
a sensor configured for finger geometry biometrics;
an iris scanner; and
a digitizing tablet or capacitive touchscreen configured for signature or handwriting recognition.

9. The biometric system of claim 1, wherein said indexed array of keys corresponds to an indexed array of reference biometric templates that are associated with a plurality of biometric inputs.

10. The biometric system of claim 1, wherein the authorization system is one or more of the following:
a payment network system; and
an issuer processor system.

11. The biometric system of claim 1, wherein the cardholder data includes one or more of the following:
data representing a payment card number (PAN); and
data representing an identifier associated with the cardholder.

12. The biometric system of claim 1, wherein the cardholder data further includes one or more of the following:
a key;
a reference biometric template associated with the key; and
data indicating biometric input associated with the reference biometric template associated with the key.

13. The biometric system of claim 12, wherein responsive to a determination that the indexed array of keys corresponds to an indexed array of reference biometric templates that are associated with a plurality of biometric inputs, the biometric system is further configured to compare data representing biometric input from the purchaser with the data indicating biometric input associated with the reference biometric template associated with the key.

14. A biometric method for authenticating a biometric request received from a payment terminal, performed by one or more processors in communication with non-transitory data storage having instructions stored thereon, the method comprising:
receiving a payment request from the payment terminal, the payment request including cardholder data and a biometric authentication request;
retrieving, from data storage, a key associated with the cardholder data;
sending, to the payment terminal, message data representing said key;
receiving, from the payment terminal, data representing biometric input from a purchaser;
retrieving, from data storage, a reference biometric template associated with the key;
comparing said data representing biometric input from the purchaser with the reference biometric template associated with the key;
responsive to a determination that said data representing biometric input from the purchaser matches with the reference biometric template associated with the key:
generating message data representing a payment authorization request including an indication that the biometric input from the purchaser matches with the reference biometric template associated with the key; and
sending, to an authorization system, the message data.

15. A biometric payment device for authenticating a transaction for a purchaser that is initiated by a payment terminal, comprising one or more processors in communication with a biometric sensor and non-transitory data storage having instructions stored thereon which, when executed by the processor or processors, configure the device to:
receive a request for biometric authentication from the payment terminal in communication with the biometric payment device;
retrieve, from data storage, a key associated with a reference biometric template;
send said key to the payment terminal;
receive, from the biometric sensor, data representing biometric input from the purchaser;
retrieve, from data storage, the reference biometric template associated with the key;
compare said data representing biometric input from the purchaser with the reference biometric template associated with the key;
responsive to a determination that said data representing biometric input from the purchaser matches with the reference biometric template associated with the key:
generate message data representing a payment authorization request including an indication that the biometric input from the purchaser matches with the reference biometric template associated with the key; and
send, to an authorization system, the message data for payment authorization.

16. The payment device of claim 15, wherein the biometric sensor is located external to the payment device and is configured for data communication with the payment device.

17. The payment device of claim 15, wherein the message data includes data representing a payment card number (PAN).

18. The payment device of claim 15, wherein the payment device is further configured to:
generate a matching score indicating how closely said data representing biometric input from the purchaser relates with the reference biometric template associated with the key; and
responsive to a determination that the matching score is within a predefined threshold, authenticate the transaction.

19. The payment device of claim 15, wherein the key is one of a plurality of keys forming part of an indexed array of keys associated with the cardholder data, wherein said indexed array of keys corresponds with an indexed array of reference biometric templates.

20. The payment device of claim 19, wherein the device is further configured to:
retrieve the size of the indexed array of keys;
apply a randomized selection of a number between zero and the size of indexed array of keys to obtain a random index number;
temporarily store, in data storage, data representing the random index number; and
retrieve a key associated with the random index number.

21. (canceled)

22. (canceled)
